(19) United States
(12) Patent Application Publication
(10) Pub. No.: US 2008/0186358 A1
(43) Pub. Date: Aug. 7, 2008

(54) Printing module for use in a large ink-jet printer

(75) Inventors: Hsien-Chang Lin, Hsi Chih City (TW); Chih-Te Yu, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/701,556

(22) Filed: Feb. 2, 2007

(51) Int. Cl. B41J 2/14

(52) U.S. Cl. 347/51

(57) ABSTRACT

A printing module for use in a large ink-jet printer includes a frame and an ink-jet unit secured to the frame. The ink-jet unit has a group of ink cartridges to emit droplets of ink onto a media to be printed. At least one irradiator is disposed at a side of the frame for casting a beam of ultraviolet light downward to irradiate and dry the droplets of ink emitted on the media, and means is provided for adjusting the position of the irradiator in forward and backward directions with respect to the frame. The printing module can be used in the large ink-jet printer to produce a sharp print.

### FIELD OF THE INVENTION

The present invention relates to a printing module for use in a large ink-jet printer and, more particularly, to a printing module in which the positions of irradiators are adjustable in forward and backward directions with respect to a frame so that droplets of ink emitted onto a mediate may be irradiated and dried a reasonable period of time later than being emitted and thus a sharp pint may be produced.

### BACKGROUND OF THE INVENTION

An ink-jet printer is a useful tool for producing print on various medias, especially for producing a single piece of print. It eliminates the necessity of making halftone plates.

Nowadays there is a large ink-jet printer that has a sliding table situated below a controllably reciprocating carriage carrying a printing module. The printing module includes a frame which supports a plurality of ink containers and a plurality of ink cartridges in fluid communication with the containers, with each cartridges provided with a bottom nozzle to emit droplets of differently colored ink onto a media to be printed.

Then the emitted droplets of ink is irradiated and dried immediately by a beam of ultraviolet light radiated from one of irradiators disposed at sides of the frame, in order to keep the produced print from being blurred by the printing module in motion.

In the conventional printing module, the irradiators are arranged at sides of the frame in such locations that the beams may produce light spots upon the media at a transverse strip where a part of the print is being produced, so that the latest droplets of ink on the media is followed and dried immediately by one of the light spots. However, these droplets will be inevitably absorbed by the media in a rate varying with the nature of the media, particularly of a coating on the media, if it is coated with.

Actually, the sharpness of the produced print relies on the absorbability of the media. To achieve the optical sharpness, droplets of ink emitted on a less absorbent media should remain on the media for a relatively long period of time and not be dried until they turn into tiny dots in a desired size. Only those emitted on an absorbent media should be dried immediately in order to prevent them from becoming dots in an undesirable large size which may result in a blurred print.

Therefore, there is a need for an improved printing module to overcome the shortcomings of the prior art.

### SUMMARY OF THE INVENTION

It is an object of the present invention to provide a printing module in which the positions of irradiators are adjustable in forward and backward directions with respect to a frame so that droplets of ink emitted onto a mediate may be irradiated and dried a reasonable period of time later than being emitted and thus a sharp pint may be produced.

To achieve the aforementioned objects, the present invention provides a printing module including a frame and an ink-jet unit secured to the frame. The ink-jet unit has a group of ink cartridges to emit droplets of ink onto a media to be printed. At least one irradiator is disposed at a side of the frame for casting a beam of ultraviolet light downward to irradiate and dry the droplets of ink emitted on the media, and means is provided for adjusting the position of the irradiator in forward and backward directions with respect to the frame.

Other objects, advantages and novel features of this invention will become more apparent from the following detailed description when taken in conjunction with the accompanying drawings.

### BRIEF DESCRIPTION OF THE DRAWINGS

FIG. 1 is a front view of a first embodiment of a printing module constructed in accordance with the present invention for use in a large ink-jet printer;

FIG. 2A is a partial, exploded perspective view showing the first embodiment of the printing module;

FIG. 2B is a partial, perspective view showing the printing module of FIG. 2A in assembly;

FIG. 3A is a partial, exploded perspective view showing a second embodiment of the printing module;

FIG. 3B is a partial, perspective view showing the printing module of FIG. 3A in assembly;

FIG. 4A is a partial, exploded perspective view showing a third embodiment of the printing module; and

FIG. 4B is a partial, perspective view showing the printing module of FIG. 4A in assembly.

### DETAILED DESCRIPTION OF THE PREFERRED EMBODIMENT

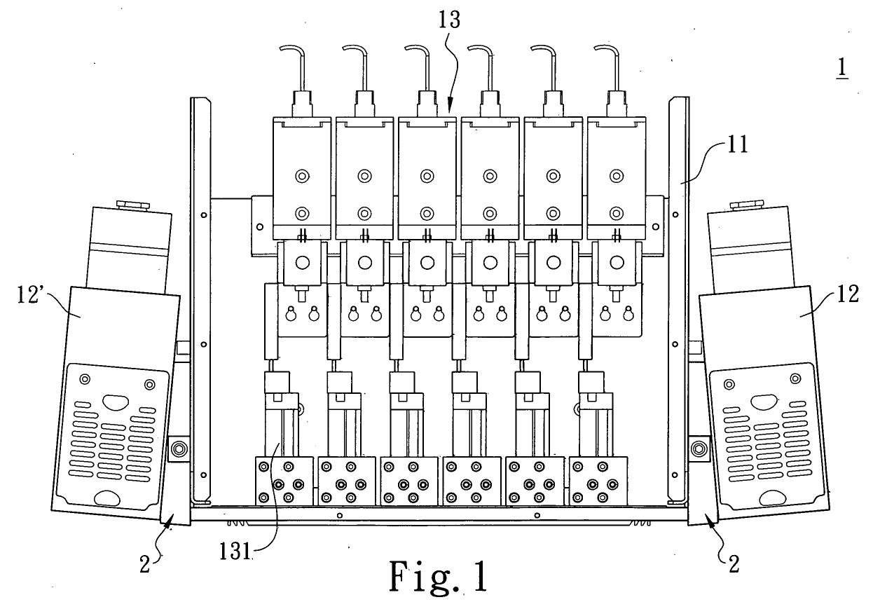

Referring to FIG. 1, there is shown a first embodiment of a printing module 1 constructed in accordance with the present invention for use in a large ink-jet printer. The printing module 1 includes a frame 11, an ink-jet unit 13 secured to the frame 11, and a pair of irradiators 12 disposed at respective sides of the frame 11.

The ink-jet unit 13 has a group of ink cartridges 131 to emit droplets of ink onto a media (not shown) to be printed, and the irradiators 12 are used for casting a beam of ultraviolet light downward to irradiate and dry the droplets of ink emitted on the media.

In the present invention, however, means 2 are provided for adjusting the positions of the irradiators 12 in forward and backward directions with respect to the frame 11. Since the means 2 are symmetrical about the frame 11, only the means 2 on the right-hand side will be described in detail hereinafter.

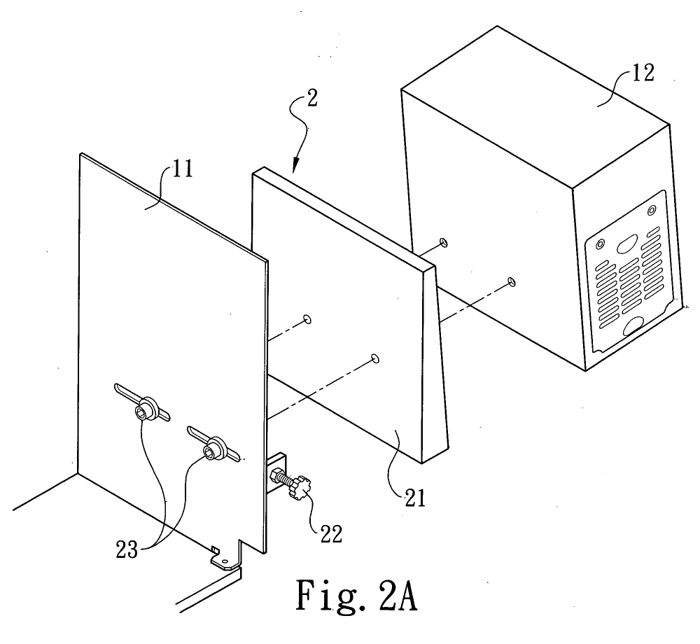

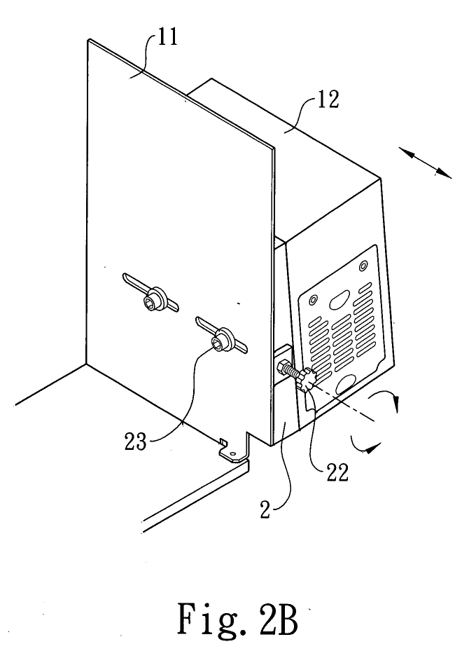

Referring to FIGS. 2A and 2B, the means 2 includes an adjusting member 21 located between the frame 11 and the irradiator 12. The frame 11 here has an additional angled portion extending laterally therefrom, and the means 2 further includes a first screw 22 located in the front end of said adjusting member, and the first screw has a shank threadedly engaged-with and extending through the additional angled portion and a distal end for abutting a front face of the adjusting member 21, as shown in FIG. 2B, to determine the position of the irradiator 12 in the forward and backward directions.

Furthermore, a plurality of second screws 23 are provided for fastening the adjusting member 21 and the irradiator 12 to the frame 11 after the adjustment.

In this way, the position of the irradiator 12 can be adjusted with respect to the frame 11 in the forward and backward directions, as designated by the double-headed arrow in FIG. 2B, depending on the nature of the media. For example, if the droplets of ink are to be emitted onto a glossy mediate which is hardly absorbent, the irradiator 12 may be adjusted into a relatively forward position so that these droplets will not be irradiated until the media has advanced in the printer by one or more steps and the droplets have turned to the tiny dots required for forming a sharp print.

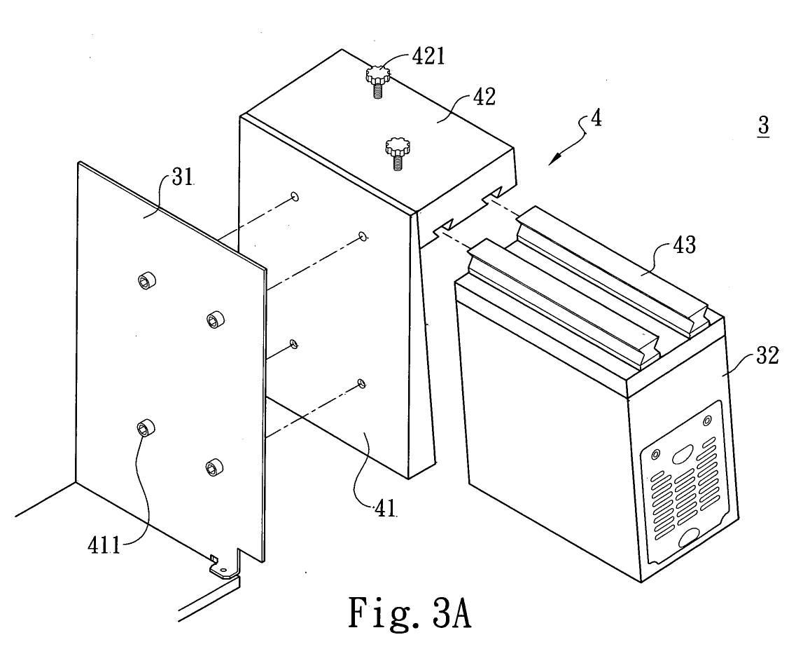

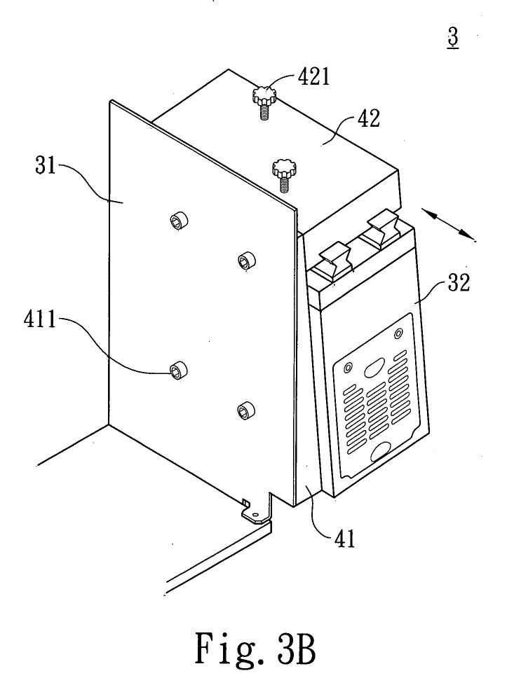

Referring to FIGS. 3A and 3B, in a second embodiment of the printing module 3, an adjusting member 41 is fastened to a frame 31, such as by screws 411. The means 4 now further includes a first forwardly extending track 42 formed on the adjusting member 41, and a second forwardly extending track 43 formed on the irradiator 32 and movably connected to the first track 42.

The tracks 42 and 43 are adapted to be fastened to each other, such as by screws 421, after the position of the irradiator 32 has been adjusted.

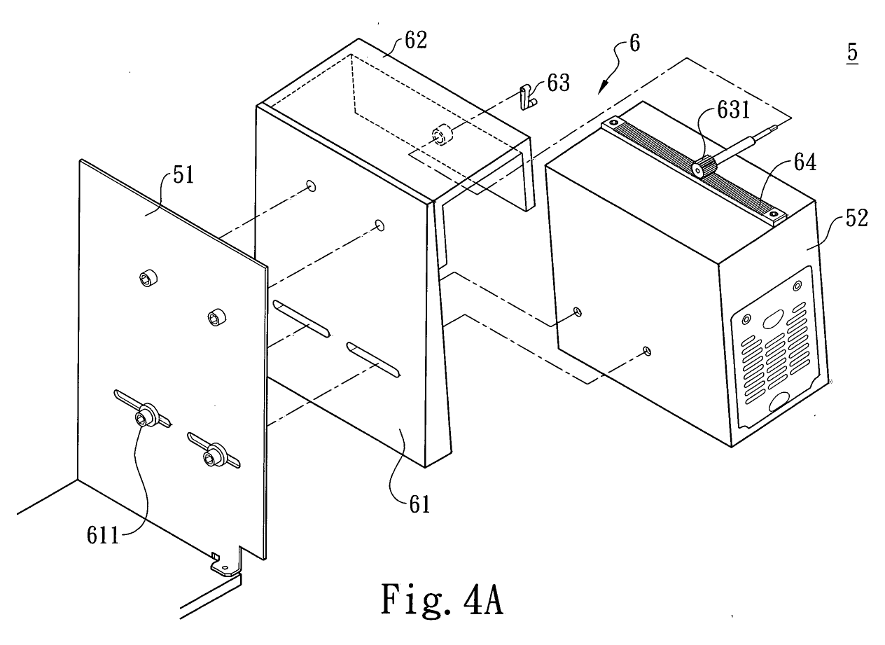

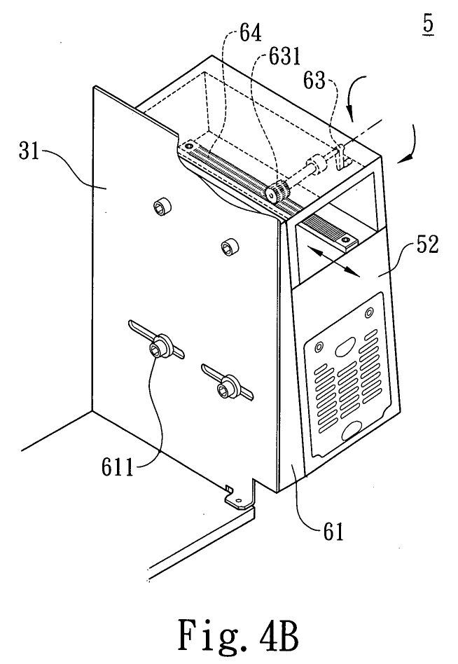

Referring to FIGS. 4A and 4B, in a third embodiment of the printing module 5, an adjusting member 61 is also fastened to a frame 51 by screws 611 but is additionally provided with a laterally extending top wing 62. The means 6 here further includes a forwardly extending rack 64 formed on a top of the irradiator 52, and a pinion 631 meshing with the rack 64 and having an integral shaft (not numbered) rotatably connected to the top wing 62.

Furthermore, the shaft of the pinion 631 has a free end formed with a handle 63, thereby enabling the irradiator 52 to be moved and adjusted in the forward and backward directions by turning the handle 63.

Although embodiments together with structures and functions of the present invention have been described in detail, many modifications and variations may be made from the teachings disclosed hereinabove. Therefore, it should be understood by those skilled in the art that any modification and variation equivalent to the spirit of the present invention be regarded to fall into the scope coved by the appended claims.

1. A printing module for use in a large ink-jet printer, comprising:
a frame;
an ink-jet unit secured to said frame, said ink-jet unit having a group of ink cartridges to emit droplets of ink onto a media to be printed;
at least one irradiator disposed at a side of said frame for casting a beam of ultraviolet light downward to irradiate and dry said droplets of ink emitted on said media; and
means for adjusting the position of said irradiator in forward and backward directions with respect to said frame.

2. The printing module as claimed in claim 1, wherein said means includes an adjusting member located between said frame and said irradiator, a first screw located in the front end of said adjusting member for abutting a front face of said adjusting member by a distal end to determine said position of said irradiator in said forward and backward directions, and at least one second screw for fastening said adjusting member and said irradiator to said frame.

3. The printing module as claimed in claim 1, wherein said means includes an adjusting member located between said frame and said irradiator and fastened to said frame, a first forwardly extending track formed on said adjusting member, and a second forwardly extending track formed on said irradiator and movably connected to said first forwardly extending track, and wherein said tracks are adapted to be fastened to each other after said position of said irradiator has been adjusted.

4. The printing module as claimed in claim 1, wherein said means includes an adjusting member located between said frame and said irradiator and provided with a laterally extending top wing, a forwardly extending rack formed on said irradiator, and a pinion meshing with said forwardly extending rack and having an integral shaft rotatably connected to said top wing of said adjusting member, and wherein said shaft has a free end provided with a handle, thereby enabling said irradiator to be moved and adjusted in said forward and backward directions by turning said handle.
